(19) United States
(12) Patent Application Publication
(10) Pub. No.: US 2024/0246518 A1
(43) Pub. Date: Jul. 25, 2024

(54) BRAKE APPARATUS AND METHOD OF CONTROLLING THE SAME

(71) Applicant: HL MANDO CORPORATION, Gyeonggi-do (KR)

(72) Inventors: Taeho JO, Seoul (KR); Mijeong Jang, Gyeonggi-do (KR); Dooyoung Yang, Gyeonggi-do (KR); Kyoungjin Joo, Gyeonggi-do (KR)

(21) Appl. No.: 18/379,174

(22) Filed: Oct. 12, 2023

(30) Foreign Application Priority Data
Jan. 19, 2023 (KR) 10-2023-0008305

(51) Int. Cl. B60T 8/40; B60T 13/74

(52) U.S. Cl. CPC B60T 8/4081; B60T 13/745

(57) ABSTRACT

A brake apparatus capable of identifying an out-of-order state or an out-of-control state of a brake includes a master cylinder, a pump including a cylinder block and a piston configured to linearly move in the cylinder block, a motor configured to provide force for linearly moving the piston, first valves provided on a first flow path extending from the pump to a wheel cylinder, at least one second valve provided on a second flow path extending from the master cylinder to the wheel cylinder, and a processor configured to control the first valves to open the first flow path, control the second valve to block the second flow path, and control the motor to move the piston. The processor can stop the control of the motor and control the second valve to open the second flow path based on a rotating speed and a driving current of the motor.

### CROSS-REFERENCE TO RELATED APPLICATION

This application claims the benefit of Korean Patent Application No. 10-2023-0008305, filed on Jan. 19, 2023 in the Korean Intellectual Property Office, the disclosure of which is incorporated herein by reference in its entirety.

### BACKGROUND

### 1. Technical Field

Embodiments of the present disclosure generally relate to a brake apparatus for providing a braking pressure using a piston pump or plunger pump driven by a motor, and a method of controlling the same.

### 2. Description of the Related Art

A brake system for performing braking is necessarily installed on vehicles, and various types of brake systems have been developed for the safety of drivers and passengers.

Conventional brake systems have provided a hydraulic pressure (pressure of a brake oil) required for braking to wheel cylinders using a mechanically connected booster when a driver steps on a brake pedal. However, as the market demand for implementing various braking functions specifically in response to operating environments of vehicles increases, an electronic brake system including a hydraulic supply unit for receiving electrical signals corresponding to a driver's braking intention from a pedal travel sensor for detecting displacement of a brake pedal when the driver steps on the brake pedal and supplying a hydraulic pressure required for braking to wheel cylinders has been widely used.

However, autonomous driving vehicles in which a driver is not directly involved in the traveling of the vehicle and the driver does not manipulate a brake pedal are being developed. Therefore, when the electronic brake system is in a state of being out of order or out of control, an auxiliary means capable of providing a braking force may be required.

### SUMMARY

Therefore, it is an aspect of the present disclosure to provide an apparatus capable of detecting an abnormal state, a failure state, an out-of-order state or an out-of-control state of a brake.

Additional aspects of the disclosure will be set forth in part in the description which follows and, in part, will be obvious from the description, or may be learned by practice of the disclosure.

In accordance with one aspect of the present disclosure, a brake apparatus includes a master cylinder, a pump including a cylinder block and a piston configured to linearly move in the cylinder block, a motor configured to provide rotation for linearly moving the piston, a plurality of first valves provided on a first flow path extending from the pump to a wheel cylinder, at least one second valve provided on a second flow path extending from the master cylinder to the wheel cylinder, and a processor configured to control the plurality of first valves to open the first flow path, control the at least one second valve to block the second flow path, and control the motor to move the piston in a first direction. The processor stops the control of the motor and controls the at least one second valve to open the second flow path based on a rotating speed of the motor and a driving current of the motor while controlling the motor.

The processor may set a target pressure based on an output signal of a pedal travel sensor, and set a target current based on the target pressure.

The processor may stop the control of the motor and control the at least one second valve to open the second flow path, based on the rotating speed of the motor being lower than a reference speed and a difference between the driving current of the motor and the target current of the motor being greater than a reference value.

The processor may stop the control of the motor and control the at least one second valve to open the second flow path, when a state in which the rotating speed of the motor is lower than a reference speed and a difference between the driving current of the motor and the target current of the motor is greater than a reference value continues for a reference time or longer.

The processor may stop the control of the motor and control the at least one second valve to open the second flow path, based on the piston being positioned in a monitoring region, the rotating speed of the motor being lower than a reference speed, and a difference between the driving current of the motor and a target current of the motor being greater than a reference value.

The processor may continue the control of the motor without stopping the control of the motor for a first time after starting to control the motor to move the piston in the first direction.

The processor may control the motor to move the piston in a second direction based on the piston close to an edge of the cylinder block.

The cylinder block may be divided into a first chamber and a second chamber by the piston. The processor may control the plurality of first valves to open a third flow path extending from the first chamber to the wheel cylinder while controlling the motor to move the piston in the first direction, and control the plurality of first valves to open a fourth flow path extending from the second chamber to the wheel cylinder while controlling the motor to move the piston in the second direction.

In accordance with another aspect of the present disclosure, a method of controlling a brake apparatus including a master cylinder, a pump including a cylinder block and a piston configured to linearly move in the cylinder block, a motor configured to provide rotation for linearly moving the piston, a plurality of first valves provided on a first flow path extending from the pump to a wheel cylinder, and at least one second valve provided on a second flow path extending from the master cylinder to the wheel cylinder includes controlling the plurality of first valves to open the first flow path, controlling the at least one second valve to block the second flow path, controlling the motor to move the piston in a first direction, and stopping the controlling of the motor and controlling the at least one second valve to open the second flow path based on a rotating speed of the motor and a driving current of the motor while performing the controlling of the motor.

The method may further include setting a target pressure based on an output signal of a pedal travel sensor, and setting a target current based on the target pressure.

The stopping of the controlling of the motor and the controlling of the at least one second valve includes stopping the controlling of the motor and controlling the at least one second valve to open the second flow path, based on the rotating speed of the motor being lower than a reference speed and a difference between the driving current of the motor and the target current of the motor being greater than a reference value.

The stopping of the controlling of the motor and the controlling of the at least one second valve includes stopping the controlling of the motor and controlling the at least one second valve to open the second flow path, when a state in which the rotating speed of the motor is lower than a reference speed and a difference between the driving current of the motor and the target current of the motor is greater than a reference value continues for a reference time or longer.

The stopping of the controlling of the motor and the controlling of the at least one second valve includes stopping the controlling of the motor and controlling the at least one second valve to open the second flow path, based on the piston being positioned in a monitoring region, the rotating speed of the motor being lower than a reference speed, and a difference between the driving current of the motor and the target current of the motor being greater than a reference value.

The method may further includes continuing the control of the motor without stopping controlling the motor for a first time after starting to control the motor to move the piston in the first direction.

The method may further includes controlling the motor to move the piston in a second direction based on the piston close to an edge of the cylinder block.

In accordance with one aspect of the present disclosure, a brake apparatus includes a master cylinder, a pump including a cylinder block and a piston configured to divide the cylinder block into a first chamber and a second chamber and linearly move in the cylinder block, a motor configured to provide rotation for linearly moving the piston, a plurality of first valves provided on a first flow path extending from at least one of the first chamber or the second chamber to a wheel cylinder, at least one second valve provided on a second flow path extending from the master cylinder to the wheel cylinder, and a processor configured to control the plurality of first valves so that the first flow path extends from the first chamber to the wheel cylinder, control the at least one second valve to block the second flow path, and control the motor to move the piston in a first direction. The processor controls the plurality of first valves so that the first flow path extends from the second chamber to the wheel cylinder, controls the at least one second valve to block the second flow path, and controls the motor to move the piston in a second direction based on the piston close to an edge of the cylinder block. The processor stops the control of the motor and controls the at least one second valve to open the second flow path based on a rotating speed of the motor and a driving current of the motor while controlling the motor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a conceptual diagram for illustrating a brake device according to an embodiment of the present disclosure;

FIG. 2 is a conceptual diagram for illustrating a hydraulic structure of a hydraulic device included in a brake device according to another embodiment of the present disclosure;

FIG. 3 is a hydraulic structure of a hydraulic device included in a brake device according to another embodiment of the present disclosure;

FIG. 4 is a diagram for illustrating a control configuration of a brake device according to an embodiment of the present disclosure;

FIG. 5 is a flowchart for illustrating a method of detecting a stuck state of a hydraulic piston by a brake device according to an embodiment of the present disclosure;

FIG. 6 illustrates one example of a stuck monitoring region SM of a brake device according to an embodiment of the present disclosure;

FIG. 7 is graphs illustrating examples of a hydraulic pressure, a rotating speed of a motor, a position of a hydraulic piston, and a driving current according to an embodiment of the present disclosure;

FIG. 8 is a flowchart for illustrating a method of detecting a stuck state of a hydraulic piston by a brake device according to an embodiment of the present disclosure; and

FIG. 9 is graphs illustrating examples of a hydraulic pressure, a rotating speed of a motor, a position of a hydraulic piston, and a driving current according to the embodiment illustrated in FIG. 8.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

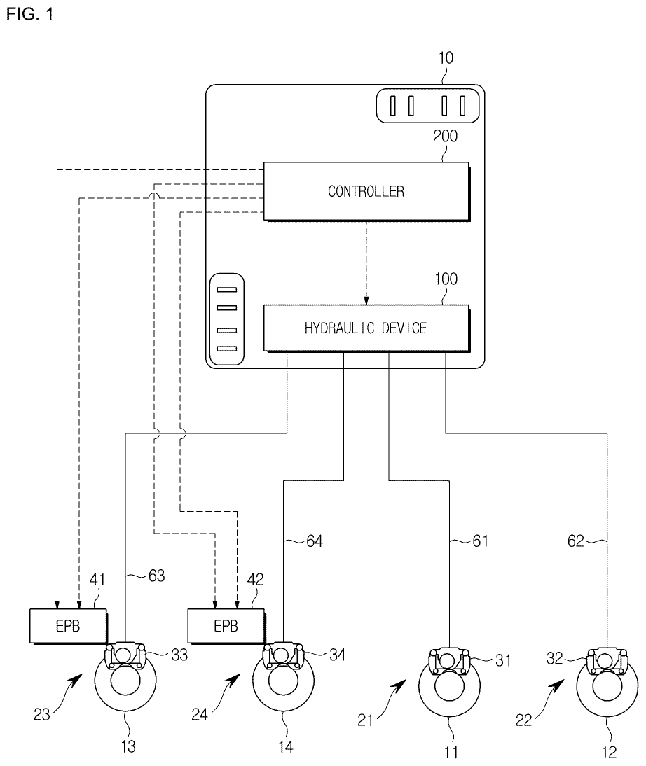

FIG. 1 is a conceptual diagram for illustrating a brake device according to an embodiment of the present disclosure.

As illustrated in FIG. 1, a brake disk rotating with each of wheels 11, 12, 13, and 14 is provided on each of the wheels 11, 12, 13, and 14, and brake calipers 21, 22, 23, and 24 for slowing down or stopping the rotation of the wheels 11, 12, 13, and 14 are respectively provided on the wheels 11, 12, 13, and 14. Each of the brake calipers 21, 22, 23, and 24 may include, for example, a pair of brake pads provided on both sides of the brake disk to press the brake disk.

The brake calipers 21, 22, 23, and 24 include wheel cylinders 31, 32, 33, and 34, respectively, for receiving a hydraulic pressure and allowing the pair of brake pads to press the brake disk. For example, the wheel cylinders 31, 32, 33, and 34 may include the first wheel cylinder 31 installed on the first brake caliper 21, the second wheel cylinder 32 installed on the second brake caliper 22, the third wheel cylinder 33 installed on the third brake caliper 23, and the fourth wheel cylinder 34 installed on the fourth brake caliper 24.

Parking brakes 41 and 42 may be provided on at least two or more of the brake calipers 21, 22, 23, and 24. For example, the parking brakes 41 and 42 may be provided on the third and fourth brake calipers 23 and 24, respectively, among the brake calipers 21, 22, 23, and 24. The first parking brake 41 may be provided on the third brake caliper 23, and the second parking brake 42 may be provided on the fourth brake caliper 24.

A device capable of moving the brake pads by an electro-mechanical force without hydraulic pressure may be provided on each of the first and second parking brakes 41 and 42. For example, each of the first and second parking brakes 41 and 42 may include a motor having a rotating shaft and a spindle reciprocating by the rotation of the rotating shaft of the motor. The spindle may move or reciprocate the brake pads by the rotation of the rotating shaft of the motor.

Each of the first and second parking brakes 41 and 42 may press the brake pad toward the brake disk in response to a brake apply signal. In addition, each of the first and second parking brakes 41 and 42 may retract the brake pads from the brake disk in response to a brake release signal.

An electronic brake system 10 includes a hydraulic device 100 for generating a hydraulic pressure for braking of a vehicle and a controller 200 for controlling an operation of the hydraulic device 100.

The hydraulic device 100 may generate the hydraulic pressure for generating a braking force in the wheels 11, 12, 13, and 14. The hydraulic device 100 may detect a driver's braking intention through, for example, a brake pedal 50. The hydraulic device 100 may generate the hydraulic pressure based on the driver's braking intention such as a moving distance and/or a moving speed of the brake pedal 50, and provide the generated hydraulic pressure to the wheel cylinders 31, 32, 33, and 34 through transmission flow paths 61, 62, 63, and 64. The transmission flow paths 61, 62, 63, and 64 may include the first transmission flow path 61 connected from the hydraulic device 100 to the first wheel cylinder 31, the second transmission flow path 62 connected from the hydraulic device 100 to the second wheel cylinder 32, the third transmission flow path 63 connected from the hydraulic device 100 to the third wheel cylinder 33, and the fourth transmission flow path 64 connected from the hydraulic device 100 to the fourth wheel cylinder 34.

Internal pressures of the wheel cylinders 31, 32, 33, and 34 may depend on the hydraulic pressure provided from the hydraulic device 100. Depending on the internal pressures of the wheel cylinders 31, 32, 33, and 34, braking forces may be generated in the wheels 11, 12, 13, and 14.

The controller 200 may control the operation of the hydraulic device 100. For example, the controller 200 may control a hydraulic pressure supply unit 130 to generate the hydraulic pressure based on an output of a pedal travel sensor (PTS).

The controller 200 may control the first parking brake 41 and the second parking brake 42. The controller 200 may provide the brake apply signal to each of the first and second parking brakes 41 and 42 so that the parking brake can be engaged in response to a driver's parking brake engagement command or instruction through a parking button or the like or a predetermined control signal or provide the brake release signal to each of the first and second parking brakes 41 and 42 so that the parking brake is released in response to a driver's parking brake release command or instruction through the parking button or the like or a predetermined control signal.

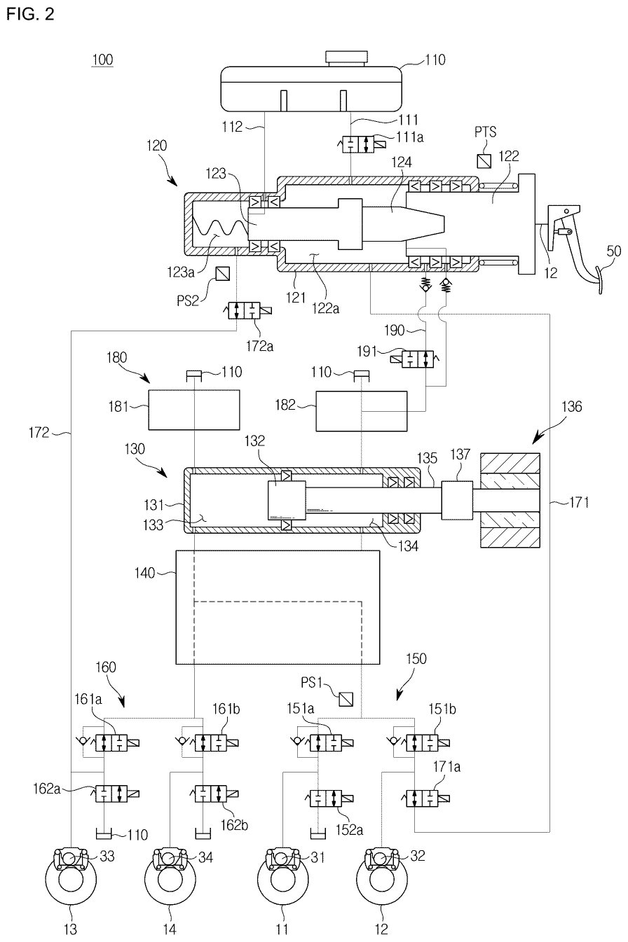

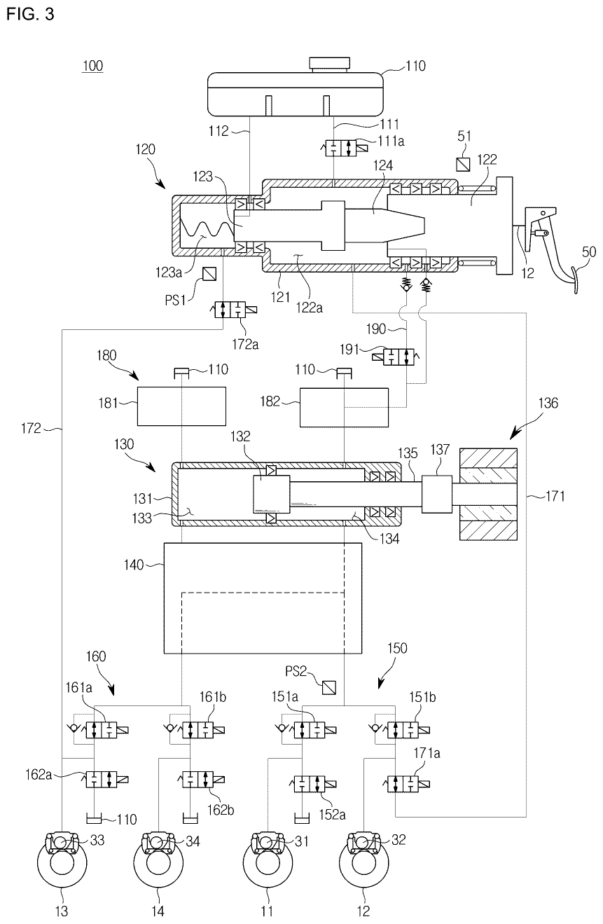

FIG. 2 is a conceptual diagram for illustrating a hydraulic structure of a hydraulic device included in a brake device according to another embodiment of the present disclosure. FIG. 3 is a hydraulic structure of a hydraulic device included in a brake device according to another embodiment of the present disclosure.

As illustrated in FIGS. 2 and 3, the hydraulic device 100 may include a reservoir 110 storing a medium therein, a master cylinder 120 configured to provide a driver with a reaction or feedback force according to or in response to a pedal force of the brake pedal 50 and pressurizing and discharging the pressurized medium such as a brake oil accommodated therein, a hydraulic pressure supply unit 130 configured to receive an electrical signal representative of a driver's braking intention from the pedal travel sensor (PTS) for detecting displacement of the brake pedal 50 and generating the hydraulic pressure of the pressurizing medium through a mechanical operation, a hydraulic control unit 140 configured to control the hydraulic pressure provided from the hydraulic pressure supply unit 130, hydraulic circuits 150 and 160 including the wheel cylinders 31, 32, 33, and 34 for receiving the hydraulic pressure of the medium and performing braking of each of the wheels 11, 12, 13, and 14, backup flow paths 171 and 172 hydraulically connecting the master cylinder 120 and the hydraulic circuits 150 and 160, a dump control unit 180 provided between the hydraulic pressure supply unit 130 and the reservoir 110 to control a flow of the medium, and an inspection flow path 190 connected to a master chamber of the master cylinder 120.

One or more of the reservoir 110, the master cylinder 120, the hydraulic pressure supply unit 130, the hydraulic control unit 140, the hydraulic circuits 150 and 160, the backup flow paths 171 and 172, the dump control unit 180, reservoir flow paths 111 and 112, and the inspection flow path 190 may not be essential components of the hydraulic device 100, and one or more of the above-described components may be omitted.

When the driver applies the pedal force to the brake pedal 50 for a braking operation, the master cylinder 120 may provide a stable or natural pedal feel by providing the driver with the reaction force according to the pedal force. In addition, the master cylinder 120 may be provided to pressurize and discharge the pressurized medium accommodated therein by the operation of the brake pedal 50.

The master cylinder 120 may include a cylinder body 121 forming a chamber therein, a first master chamber 122a formed at an inlet side of the cylinder body 121 to which the brake pedal 50 is connected, a first master piston 122 provided in the first master chamber 122a and operably connected to the brake pedal 50 to be displaced by the operation or displacement of the brake pedal 50, a second master chamber 123a formed at an inner side or a front side (e.g. a left side in FIGS. 2 and 3) than the first master chamber 122a, a second master piston 123 provided in the second master chamber 123a and provided to be displaced by the displacement of the first master piston 122 or the hydraulic pressure of the pressurizing medium accommodated in the first master chamber 122a, and a pedal simulator 124 disposed between the first master piston 122 and the second master piston 123 to provide a pedal feel through an elastic restoring force generated upon compression.

One or more the cylinder body 121, the first master chamber 122a, the first master piston 122, the second master chamber 123a, the second master piston 123, and the pedal simulator 124 may not be essential components of the master cylinder 120, and one or more of the above-described components may be omitted.

The first master piston 122 and the second master piston 123 are respectively provided in the first master chamber 122a and the second master chamber 123a to generate a hydraulic pressure or a negative pressure in the medium accommodated in each chamber according to the forward and the rearward movement of the first master piston 122 and the second master piston 123.

The pedal simulator 124 may be disposed or provided between the first master piston 122 and the second master piston 123, and may be configured to provide the pedal feel of the brake pedal 50 to the driver by the elastic restoring force thereof.

The reservoir 110 may accommodate and store the medium therein. The reservoir 110 may be connected to each component such as the master cylinder 120, the hydraulic pressure supply unit 130, or a hydraulic circuit to supply or receive the pressurizing medium.

The reservoir flow paths 111 and 112 hydraulically connecting the reservoir 110 and the master cylinder 120 may be provided between the reservoir 110 and the master cylinder 120. The first reservoir flow path 111 connects the first master chamber 122a of the master cylinder 120 and the reservoir 110, and the second reservoir flow path 112 connects the second master chamber 123a of the master cylinder 120 and the reservoir 110. A simulator valve 111a may be provided on the first reservoir flow path 111 so that a flow of the medium between the reservoir 110 and the first master chamber 122a through the first reservoir flow path 111 can be controlled by the simulator valve 111a.

The hydraulic pressure supply unit 130 may be configured to receive an electrical signal associated with or representative of the driver's braking intention from the PTS configured to detect the displacement of the brake pedal 50 and generate the hydraulic pressure of the pressurizing medium through a mechanical operation.

The hydraulic pressure supply unit 130 may include a cylinder block 131 configured to accommodate the medium therein, a hydraulic piston 132 movably accommodated in the cylinder block 131, pressure chambers 133 and 134 divided by the hydraulic piston 132 and the cylinder block 131, a motor 136 configured to generate a rotating force, a power conversion unit 137 configured to convert the rotating force of the motor 136 into the translational movement of the hydraulic piston 132, and a driving shaft 135 for transmitting power to the hydraulic piston 132. The power conversion unit 137 may comprise, for example, but not limited to, a nut and a screw to convert the rotational movement to the linear movement.

One or more of the cylinder block 131, the hydraulic piston 132, the pressure chambers 133 and 134, the motor 136, the power conversion unit 137, and the driving shaft 135 may not be essential components of the hydraulic pressure supply unit 130, and one or more of the above-described components may be omitted.

The first pressure chamber 133 is positioned in front of the hydraulic piston 132 (e.g. a left side of the hydraulic piston 132 in FIGS. 2 and 3) and the second pressure chamber 134 is positioned behind the hydraulic piston 132 (e.g. a right side of the hydraulic piston 132 in FIGS. 2 and 3). That is, the first pressure chamber 133 may be formed or provided in the cylinder block 131, divided by a front surface of the hydraulic piston 132, and configured or provided to have a variable volume of the first pressure chamber 133 depending on the movement of the hydraulic piston 132. In addition, the second pressure chamber 134 may be formed or provided in the cylinder block 131, divided by a rear surface of the hydraulic piston 132, and provided to have a variable volume of the second pressure chamber 134 depending on the movement of the hydraulic piston 132.

When the displacement of the brake pedal 50 in a direction of applying a brake is detected by the PTS, the hydraulic piston 132 may generate the hydraulic pressure in the first pressure chamber 133 while moving forward in the cylinder block 131. Conversely, when the pedal force applied to the brake pedal 50 is released, the hydraulic piston 132 may generate the negative pressure in the first pressure chamber 133 while moving backward in the cylinder block 131. The generation of the hydraulic pressure and the negative pressure in the second pressure chamber 134 may be implemented by an operation in an opposite direction to the operation of the first pressure chamber 133 described above.

As described above, the hydraulic pressure supply unit 130 may generate the hydraulic pressure or the negative pressure in each of the first pressure chamber 133 and the second pressure chamber 134 by the motor 136.

The hydraulic pressure supply unit 130 may be hydraulically connected to the reservoir 110 through the dump control unit 180. The dump control unit 180 may include at least one flow path and at least one valve to control the flow of the medium between the hydraulic pressure supply unit 130 and the reservoir 110.

The hydraulic control unit 140 may be configured to control the hydraulic pressure transmitted to each of the wheel cylinders 31, 32, 33, and 34.

The hydraulic control unit 140 is branched into the first hydraulic circuit 150 for controlling the flows of the hydraulic pressures transmitted to the first and second wheel cylinders 31 and 32 and the second hydraulic circuit 160 for controlling the flows of the hydraulic pressures transmitted to the third and fourth wheel cylinders 33 and 34. The hydraulic control unit 140 may include at least one flow path and at least one valve in order to guide the hydraulic pressure, which is transmitted from the hydraulic pressure supply unit 130 to the wheel cylinder 30, to the first hydraulic circuit 150 and the second hydraulic circuit 160.

The hydraulic control unit 140 may have or form flow paths for providing the pressurized medium to the first hydraulic circuit 150 and the second hydraulic circuit 160 using a pressure of the first pressure chamber 133 generated by the forward movement of the hydraulic piston 132. For example, as illustrated in FIG. 2, the hydraulic control unit 140 may form flow paths connecting the first pressure chamber 133 to the first and second hydraulic circuits 150 and 160. The pressurized medium in the first pressure chamber 133 may be provided to the first and second hydraulic circuits 150 and 160 through the hydraulic control unit 140.

The hydraulic control unit 140 may have or form flow paths for providing the pressurized medium to the first hydraulic circuit 150 and the second hydraulic circuit 160 using a pressure of the second pressure chamber 134 generated by the rearward of the hydraulic piston 132. For example, as illustrated in FIG. 3, the hydraulic control unit 140 may form flow paths connecting the second pressure chamber 134 to the first and second hydraulic circuits 150 and 160. The pressurized medium in the second pressure chamber 134 may be provided to the first and second hydraulic circuits 150 and 160 through the hydraulic control unit 140.

The hydraulic control unit 140 may have or form flow paths for returning the media from the first hydraulic circuit 150 and the second hydraulic circuit 160 using the negative pressure of the first pressure chamber 133 generated by the rearward of the hydraulic piston 132. For example, as illustrated in FIG. 2, the hydraulic control unit 140 may have or form flow paths connecting the first pressure chamber 133 to the first and second hydraulic circuits 150 and 160. The media in the first and second hydraulic circuits 150 and 160 may be provided to the first pressure chamber 133 through the hydraulic control unit 140.

The hydraulic control unit 140 may have or form flow paths for returning the pressurizing media from the first hydraulic circuit 150 and the second hydraulic circuit 160 using the negative pressure of the second pressure chamber 134 generated by the forward movement of the hydraulic piston 132. For example, as illustrated in FIG. 3, the hydraulic control unit 140 may form flow paths connecting the second pressure chamber 134 to the first and second hydraulic circuits 150 and 160. The media in the first and second hydraulic circuits 150 and 160 may be provided to the second pressure chamber 134 through the hydraulic control unit 140.

The first hydraulic circuit 150 may adjust and control the hydraulic pressure applied to the first and second wheel cylinders 31 and 32, and the second hydraulic circuit 160 may adjust and control the hydraulic pressure applied to the third and fourth wheel cylinders 33 and 34.

The first and second hydraulic circuits 150 and 160 may include first to fourth inlet valves 151a, 151b, 161a, and 161b to control the flows and hydraulic pressures of the pressurizing media transmitted to the first to fourth wheel cylinders 31, 32, 33, and 34. Each of the first to fourth inlet valves 151a, 151b, 161a, and 161b may be disposed at one of upstream sides of the first to fourth wheel cylinders 31, 32, 33, and 34 and may be provided as a normal open type solenoid valve, but not limited thereto.

The second hydraulic circuit 160 may include first and second outlet valves 162a and 162b for controlling the flows of the pressurized media discharged from the third and fourth wheel cylinders 33 and 34 in order to improve performance when the braking of the third and fourth wheel cylinders 33 and 34 is released. Each of the first and second outlet valves 162a and 162b may be provided at one of discharge sides of the third and fourth wheel cylinders 33 and 34 to control the flows of the pressurized media transmitted from the third and fourth wheel cylinders 33 and 34 to the reservoir 110. The first and second outlet valves 162a and 162b may be provided as normally closed type solenoid valves, but not limited thereto.

The first hydraulic circuit 150 may include a third outlet valve 152a for controlling the flow of the pressurized medium discharged from the first wheel cylinder 31 in order to improve performance when the braking of the first wheel cylinder 31 is released. The third outlet valve 152a may be provided at the discharge side of the first wheel cylinder 31 to control the flow of the pressurized medium transmitted from the first wheel cylinder 31 to the reservoir 110. The third outlet valve 152a may be provided as a normally closed type solenoid valve, but not limited thereto.

The second wheel cylinder 32 of the first hydraulic circuit 150 may be connected to the first pressure backup flow path 171, and a first cut valve 171a may be provided on the first backup flow path 171 to control the flow of the pressurized medium between the second wheel cylinder 32 and the master cylinder 120.

When a normal operation is impossible due to a failure of the device or the like or when it is determined that the hydraulic device 100 is in an abnormal state or a failure state, the electronic brake system 10 may open or connect the first and second backup flow paths 171 and 172 to directly supply the pressurized medium discharged from the master cylinder 120 to the wheel cylinders 31, 32, 33, and 34 to perform a brake operation. A mode in which the hydraulic pressure of the master cylinder 120 is directly transmitted to the wheel cylinders 31, 32, 33, and 34 may be referred to as an “abnormal operation mode,” that is, a “fallback mode” In the present disclosure.

The first backup flow path 171 may be provided to connect the first master chamber 122a of the master cylinder 120 and the first hydraulic circuit 150, and the second backup flow path 172 may be provided to connect the second master chamber 123a of the master cylinder 120 and the second hydraulic circuit 160.

At least one first cut valve 171a configured to control the flow of the pressurized medium in both directions may be provided on the first backup flow path 171, and a second cut valve 172a configured to control the flow of the pressurized medium in both directions may be provided on the second backup flow path 172. The first cut valve 171a and the second cut valve 172a may be provided as normal open type solenoid valves, but not limited thereto.

When the first and second cut valves 171a and 172a are closed, the pressurized medium of the master cylinder 120 can be prevented from being directly transmitted from the master cylinder 120 to the wheel cylinders 31, 32, 33, and 34, and at the same time, the hydraulic pressure provided from the hydraulic pressure supply unit 130 can be prevented from leaking to the master cylinder 120. In addition, when the first and second cut valves 171a and 172a are opened, the medium pressurized in the master cylinder 120 may be supplied to the first and second hydraulic circuits 150 and 160 through the first and second backup flow paths 171 and 172 to perform the brake operation.

The inspection flow path 190 may connect the master cylinder 120 and the dump control unit 180 and provided to inspect whether a leak occurs or is present in various components mounted on the master cylinder 120 and the simulator valve 112a.

The hydraulic device 100 may include a first pressure sensor PS1 for measuring the hydraulic pressure of the medium provided by the hydraulic pressure supply unit 130 and a second pressure sensor PS2 for measuring the hydraulic pressure provided by the master cylinder 120. The first pressure sensor PS1 and the second pressure sensor PS2 may output electrical signals representing the measured pressures to the controller 200.

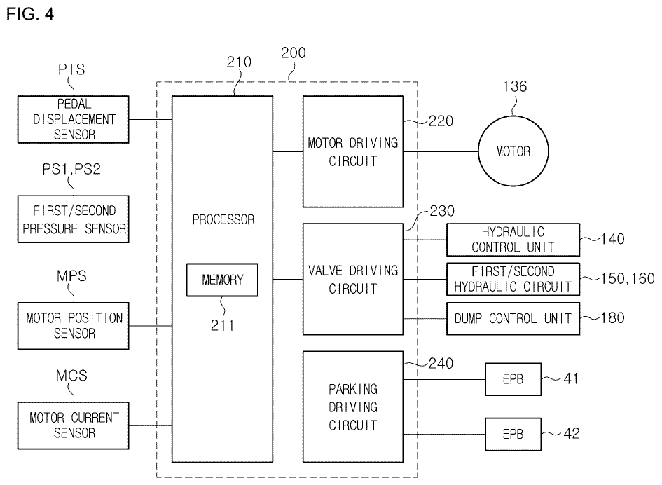

FIG. 4 is a diagram for illustrating a control configuration of a brake device according to an embodiment of the present disclosure.

As illustrated in FIG. 4, the brake device 10 may include the motor 136, the hydraulic control unit 140, the first and second hydraulic circuits 150 and 160, the dump control unit 180, the first and second parking brakes 41 and 42, the PTS, the first and second pressure sensors PS1 and PS2, a motor position sensor (MPS), a motor current sensor (MCS), a motor driving circuit 220, a valve driving circuit 230, a parking driving circuit 240, and a processor 210. One or more of the above-described components may not be essential components of the brake device 10, and one or more of the above-described components may be omitted.

The motor 136 may include the rotating shaft provided to be rotatable. The motor 136 may include a rotor connected to the rotating shaft and a stator fixed to a housing of the motor 135. For example, the rotor may include permanent magnets each having an N pole and an S pole alternately arranged along an outer surface thereof, and the stator may include a plurality of teeth arranged along the outer surface of the rotor and a plurality of coils surrounding each of the plurality of teeth.

The rotor may be rotated by magnetic interaction with the stator, and the rotation of the rotor may cause the rotation shaft to rotate. The motor 136 may receive a driving current controlled by the motor driving circuit 220. The plurality of coils included in the stator may form magnetic fields for rotating around the rotor by the driving current, and the rotor may be rotated by magnetic interaction between a magnetic field of the rotor and a magnetic field of the stator.

The hydraulic control unit 140, the first and second hydraulic circuits 150 and 160, and the dump control unit 180 may control the flow paths extending from the master cylinder 120 or the hydraulic pressure supply unit 130 to the wheel cylinders 31, 32, 33, and 34.

The hydraulic control unit 140, the first and second hydraulic circuits 150 and 160, and the dump control unit 180 may receive a driving current controlled by the valve driving circuit 230. Each of the hydraulic control unit 140, the first and second hydraulic circuits 150 and 160, and the dump control unit 180 may include at least one solenoid valve configured to be opened or closed by the driving current. For instance, the solenoid valve may include a plunger for opening or closing the flow path, a spring for applying an elastic force to the plunger, and a coil surrounding the plunger. The coil may form a magnetic field by the driving current, and the plunger may move against the elastic force of the spring by the magnetic field of the coil. Therefore, the solenoid valve may be opened or closed in response to the driving current.

A device capable of moving the brake pads by an electro-mechanical force without hydraulic pressure may be provided on each of the first and second parking brakes 41 and 42. For example, each of the first and second parking brakes 41 and 42 may include the motor having the rotating shaft and the spindle reciprocating by the rotation of the rotating shaft. The spindle may move or reciprocate the brake pads by the rotation of the rotating shaft.

Motors included in the first and second parking brakes 41 and 42, respectively, may receive a driving current controlled by the parking driving circuit 240. The motors included in the first and second parking brakes 41 and 42 may press the brake pads toward the brake disk or move the brake pads away from the brake disk by the driving current.

The PTS may be installed near the brake pedal 50 and may measure the displacement or movement of the brake pedal 50 according to the driver's braking intention. For example, the PTS may detect a displacement of the brake pedal 50 or a moving distance from a reference position and/or a moving speed of the brake pedal 50.

The PTS may be electrically connected to the processor 210 and may transmit the electrical signal (e.g. a signal representative of pedal displacement) corresponding to the moving distance and/or the moving speed of the brake pedal 50 to the processor 210. For example, the PTS may be directly connected to the processor 210 via a hard wire or connected to the processor 210 via a communication network.

The first pressure sensor PS1 may measure the hydraulic pressure discharged from the hydraulic pressure supply unit 130. The first pressure sensor PS1 may be directly connected to the processor 210 via the hard wire or connected to the processor 210 via the communication network and may provide an electrical signal (e.g. a second pressure signal) corresponding to the measured hydraulic pressure to the processor 210.

The second pressure sensor PS2 may measure the hydraulic pressure discharged from the master cylinder 120. The second pressure sensor PS2 may be directly connected to the processor 210 via the hard wire or connected to the processor 210 via the communication network and may provide an electrical signal (first pressure signal) corresponding to the measured hydraulic pressure to the processor 210.

The MPS may measure a rotating angle of the rotor of the motor 136. For example, the MPS may include a Hall sensor, and the Hall sensor may detect a periodic change in a magnetic field caused by the rotation of a permanent magnet of the rotor. The MPS may be directly connected to the processor 210 via the hard wire or connected to the processor 210 via the communication network and may provide an electrical signal (e.g. a signal representative of a position of the motor) corresponding to the measured rotating angle to the processor 210.

The MCS may measure a driving current supplied to the motor 136. For example, the MCS may include a shunt resistor and a voltage divider circuit and measure the driving current supplied to the motor 136 using the shunt resistor and the voltage divider circuit. The MCS may be directly connected to the processor 210 via the hard wire or connected to the processor 210 via the communication network and may provide an electrical signal (e.g. a signal representative of a motor current) corresponding to the measured driving current value to the processor 210.

The motor driving circuit 220 may control the driving current supplied to the motor 136 according to a motor control signal of the processor 210. For example, the motor driving circuit 220 may include a three-phase inverter including a plurality of switching elements (e.g. switches such as semiconductors like MOSFET) for controlling the driving current supplied to the motor 136 and a driver for controlling the switching elements included in the three-phase inverter according to the motor control signal of the processor 210. The driver configured to drive the invertor may provide a motor driving signal for driving the three-phase inverter to the switching elements of the three-phase inverter according to the motor control signal of the processor 210. The three-phase inverter may convert a direct current (DC) power supplied from a battery of the vehicle into an alternating current (AC) power according to the motor driving signal of the inverter driver and provide the converted AC power to the motor 136.

The valve driving circuit 230 may control the driving current supplied to the valves included in the hydraulic control unit 140, the first and second hydraulic circuits 150 and 160, and the dump control unit 180 according to the valve control signal of the processor 210. For example, the valve driving circuit 230 may include switching elements for controlling the driving current supplied to the valves and drivers for controlling the switching elements according to the valve control signal of the processor 210.

The parking driving circuit 240 may control the driving current supplied to the motors included in the first and second parking brakes 41 and 42 according to parking control signals (e.g. a parking engagement signal and a parking disengagement signal) of the processor 210. For example, the parking driving circuit 240 may include an H-bridge circuit including a plurality of switching elements for controlling driving currents supplied to the parking brake motors and an H-bridge driver for controlling the switching elements included in the H-bridge circuit according to a parking control signal of the processor 210.

The processor 210 may provide control signals for controlling the operations of the components included in the brake device 10 according to the driver's braking intention.

The processor 210 may include a memory 211 for storing programs, data, and predetermined instructions in order to perform or implement the operation of controlling the components included in the brake device 10.

The memory 211 may provide the stored programs and data to the processor 210 and store temporary data generated during operation of the processor 210. For example, the memory 211 may include, for example, but not limited to, volatile memories such as a static random access memory (SRAM) and a dynamic RAM (DRAM) and non-volatile memories such as a read only memory (ROM), an erasable programmable ROM (EPROM), and a flash memory.

The processor 210 may be electrically connected to the PTS, the first and second pressure sensors PS1 and PS2, the MPS, the MCS, the motor driving circuit 220, the valve driving circuit 230, and the parking driving circuit 240.

The processor 210 may process the electrical signals received from the PTS, the first and second pressure sensors PS1 and PS2, the MPS, and the MCS, and transmit or provide the motor control signal, the valve control signal, and the parking control signal to the motor driving circuit 220, the valve driving circuit 230, and the parking driving circuit 240, respectively, based on a result of the processing the electrical signals.

For example, the processor 210 may calculate or determine a target hydraulic pressure to be provided to the wheel cylinders 31, 32, 33, and 34 based on the pedal displacement signal of the PTS, and transmit or provide the motor control signal to the motor driving circuit 220 to move the hydraulic piston 132 in correspondence to the target pressure. In addition, the processor 210 may determine the measured pressure based on the first pressure signal of the first pressure sensor PS1 and transmit or provide the motor control signal to the motor driving circuit 220 to move the hydraulic piston 132 based on a difference between the measured pressure and the target pressure.

For example, the processor 210 may transmit or provide one motor control signal to the motor driving circuit 220 to move the hydraulic piston 123 forward and transmit or provide the valve control signal to the valve driving circuit 230 to form the flow paths extending from the first pressure chamber 133 to the wheel cylinders 31, 32, 33, and 34. In addition, the processor 210 may transmit or provide another motor control signal to the motor driving circuit 220 to move the hydraulic piston 123 backward and transmit or provide the valve control signal to the valve driving circuit 230 to form the flow paths extending from the second pressure chamber 134 to the wheel cylinders 31, 32, 33, and 34.

The processor 210 may monitor the operation of the hydraulic pressure supply unit 130 based on the motor position signal of the MPS and the motor current signal of the MCS.

The hydraulic piston 132 may be stuck in the cylinder block 131 during the forward and rearward in the cylinder block 131. When the hydraulic piston 132 is stuck in the cylinder block 131, the hydraulic piston 132 may not move, and the hydraulic pressure supply unit 130 may not supply the hydraulic pressure to the wheel cylinders 31, 32, 33, and 34. Therefore, the brake of the vehicle may not be operated appropriately or the vehicle may not be braked and may collide with another vehicle or a pedestrian.

In order to prevent such a problem, the brake device 10 may identify whether the hydraulic piston 132 is stuck in the cylinder block 131.

For example, the processor 210 may identify whether the hydraulic piston 132 is stuck in the cylinder block 131 based on the motor position signal of the MPS and the motor current signal of the MCS. Based on a result of identifying the stuck state of the hydraulic piston 132, the processor 210 may switch the operation mode of the brake device 10 to an abnormal operation mode and warn the driver of the abnormal operation of the brake device 10.

Hereinafter, a case in which the brake device 10 identifies that the hydraulic piston 132 is stuck in the cylinder block 131 will be described.

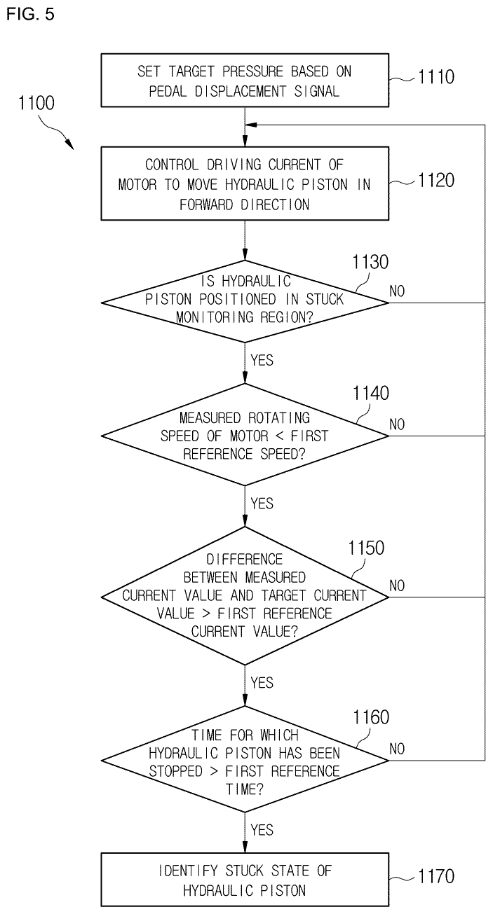

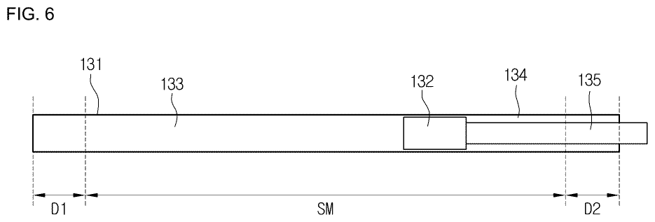

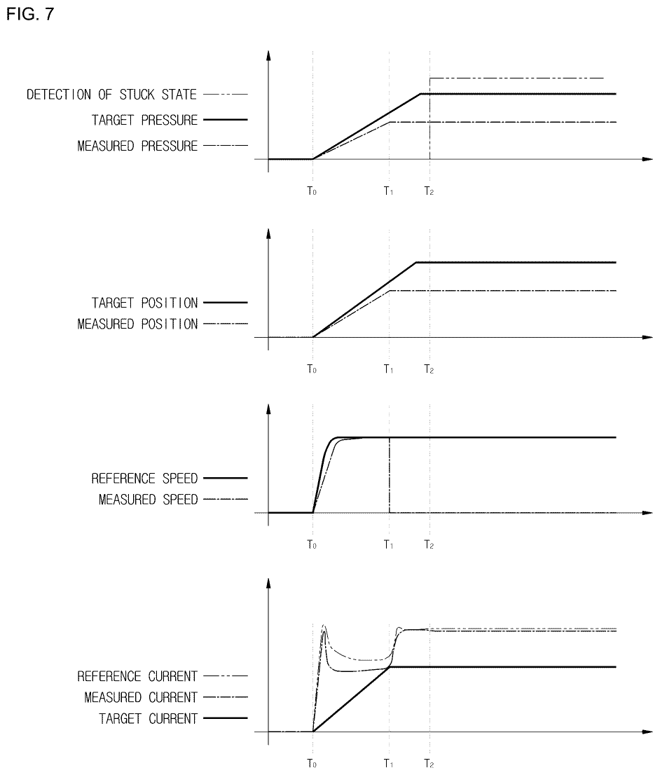

FIG. 5 is a flowchart for illustrating a method of detecting a stuck state of a hydraulic piston by a brake device according to an embodiment of the present disclosure. FIG. 6 illustrates one example of a stuck monitoring region SM of a brake device according to an embodiment of the present disclosure. FIG. 7 is graphs illustrating examples of a hydraulic pressure, a rotating speed of a motor, a position of a hydraulic piston, and a driving current according to an embodiment of the present disclosure.

A method 1100 of detecting the stuck state of the hydraulic piston by the brake device 10 will be described with reference to FIGS. 5 to 7. The method 1100 of detecting the stuck state may be executed at predetermined times.

Operations to be described below do not correspond to essential operations of the method 1100 of detecting the stuck state, and at least some of the operations may be omitted.

The brake device 10 may set the target pressure based on the pedal displacement signal (operation 1110).

The driver may press or move the brake pedal 50 to brake the vehicle. The PTS may detect the displacement or movement of the brake pedal 50, and transmit or provide an electrical signal (e.g., a pedal displacement signal) corresponding to the displacement and/or the moving speed of the brake pedal 50 to the processor 210.

The processor 210 may receive the pedal displacement signal, and identify the displacement and/or the moving speed of the brake pedal 50 based on the pedal displacement signal received from the PTS.

The processor 210 may identify the target pressure corresponding to the driver's braking intention based on the displacement and/or the moving speed of the brake pedal 50. For example, the processor 210 may identify a target deceleration corresponding to the driver's braking intention based on the displacement and/or the moving speed of the brake pedal 50, identify a target braking force (or a target braking torque) corresponding to the target deceleration, and identify a target pressure of the wheel cylinders 31, 32, 33, and 34 corresponding to the target braking force (or the target braking torque).

The displacement of the brake pedal 50 may increase according to the driver's braking intention. Therefore, as illustrated in FIG. 7, the target pressure may increase as the displacement of the brake pedal 50 increases.

The brake device 10 may control the driving current of the motor 136 to move the hydraulic piston 132 in a forward direction (i.e. a first direction) (operation 1120).

The processor 210 may have or store a pressure-volume characteristic curve. The pressure-volume characteristic curve may represent a change in a volume of the medium in the hydraulic device 100 of the brake device 10 and a change in a pressure corresponding to the volume of the medium. Here, the volume of the medium in the hydraulic device 100 may represent volumes of the media in the first hydraulic chamber (or the second hydraulic chamber), the hydraulic control unit 140, the first and second hydraulic circuits 150 and 160, and the wheel cylinders 31, 32, 33 and 34. The change in the pressure of the medium may represent an increase or a decrease in the pressure of the medium due to a decrease or an increase in the volume of the medium without a decrease or increase of the medium in the hydraulic device 100.

The processor 210 may identify a target position of the hydraulic piston 132 based on the target pressure and the pressure-volume characteristic curve.

The target pressure may increase according to the driver's braking intention. For example, as illustrated in FIG. 7, the target position of the hydraulic piston 132 may move in the forward direction (i.e. a direction away from the motor 136).

The processor 210 may identify the linear displacement of the hydraulic piston 132 based on the motor position signal of the MPS. For example, the MPS may measure the rotating displacement and the rotating speed of the motor 136, the rotation of the motor 136 may be converted into the linear movement by the power conversion unit 137, and the hydraulic piston 132 may be moved by the power conversion unit 137. The processor 210 may identify the linear displacement of the hydraulic piston 132 using the rotating displacement of the motor 136 and a pitch of the spindle included in the power conversion unit 137.

The processor 210 may identify a current position (hereinafter referred to as a “measured position”) of the hydraulic piston 132 by accumulating the linear displacement of the hydraulic piston 132 from a reference position of the hydraulic piston 132. Here, the reference position may be, for example, an edge of the cylinder block 131 in a rearward direction (i.e. a direction closer to the motor 136). That is, the reference position of the hydraulic piston 132 may be a position at which the hydraulic piston 132 has been maximally moved in the rearward direction.

The processor 210 may provide a reference speed so that the measured position of the hydraulic piston 132 follows the target position based on a difference between the target position and the measured position of the hydraulic piston 132. For example, as illustrated in FIG. 7, the reference speed may be set so that the difference between the target position and the measured position of the hydraulic piston 132 can be reduced. In this case, the reference speed may be set to a predetermined reference speed or set based on the moving speed of the brake pedal 50.

The processor 210 may identify the rotating speed (hereinafter referred to as a “measured speed”) of the motor 136 based on a motor rotation signal of the MPS.

The processor 210 may provide a reference current so that the measured speed of the motor 136 follows the reference speed based on a difference between the reference speed and the measured speed of the motor 136. For example, as illustrated in FIG. 7, the reference current may be identified so that the difference between the reference speed and the measured speed of the motor 136 can be reduced.

The processor 210 may transmit or provide the motor control signal to the motor driving circuit 220 so that the driving current of the motor 136 follows the reference current. For example, the processor 210 may identify the driving current (hereinafter referred to as a “measured current”) supplied to the motor 136 based on the motor current signal from the MCS. The processor 210 may transmit or provide the motor control signal to the motor driving circuit 220 so that the measured current can follow the reference current based on the difference between the reference current and the measured current.

The motor driving circuit 220 may control the driving current supplied to the motor 136 according to the motor control signal of the processor 210. The driving current may be supplied to the motor 136 according to the control of the processor 210 and the driving of the motor driving circuit 220.

As illustrated in FIG. 7, between time T0 and time T1, the measured current may follow the reference current, the measured speed may follow the reference speed, the measured position may follow the target position, and in addition, the measured pressure measured by the first pressure sensor PS1 may follow the target pressure.

The brake device 10 may determine or identify whether the hydraulic piston 132 is positioned in the stuck monitoring region SM (operation 1130).

The hydraulic piston 132 may move in the forward direction (i.e. a direction away from the motor 136) to generate the hydraulic pressure. That is, the hydraulic pressure may be generated while the hydraulic piston 132 is moving forward.

At this time, since a length of the cylinder block 131 is not infinite, the hydraulic piston 132 may stop after generating the hydraulic pressure by moving forward. Therefore, when the hydraulic piston 132 approaches one end of the cylinder block 131, the moving speed or the driving current of the hydraulic piston 132 may be linearly reduced to zero so as to stop the hydraulic piston 132.

In order to prevent the hydraulic piston 132 stopped at one end of the cylinder block 131 from being confused with the hydraulic piston 132 stopped due to sticking or to distinguish a normal state in which the hydraulic piston 132 is stopped at one end of the cylinder block 131 from an abnormal state in which the hydraulic piston 132 is stuck in the cylinder block 131, the processor 210 may determine or identify that the stopped hydraulic piston 132 is stuck when the hydraulic piston 132 is positioned in the stuck monitoring region SM.

Here, the stuck monitoring region SM may include an edge region of the cylinder block 131 in the forward direction and a central region of the cylinder block 131 excluding the edge region in the rearward direction. For example, as illustrated in FIG. 6, the stuck monitoring region SM may be spaced by a first distance D1 from an edge of the cylinder block 131 in the forward direction and may also be spaced by a second distance D2 from an edge of the cylinder block 131 in the rearward direction.

The processor 210 may identify the linear displacement of the hydraulic piston 132 based on the motor position signal of the MPS, and identify the measured position of the hydraulic piston 132 by accumulating the linear displacement of the hydraulic piston 132 at the reference position of the hydraulic piston 132.

The processor 210 may identify whether the measured position of the hydraulic piston 132 is in the stuck monitoring region SM.

When the processor 210 identifies that the hydraulic piston 132 is not positioned in the stuck monitoring region SM (e.g. NO in operation 1130), the brake device 10 may continuously control the driving current of the motor 136 to move the hydraulic piston 132 in the forward direction (e.g. a first direction).

When is the processor 210 identifies that the hydraulic piston 132 is positioned in the stuck monitoring region SM (e.g. YES in operation 1130), the brake device 10 may identify whether the measured speed of the motor 136 is smaller than a first reference speed (operation 1140).

The processor 210 may identify the measured speed of the motor 136 based on the motor position signal of the MPS.

The hydraulic piston 132 may be stuck to the cylinder block 131 while moving in the cylinder block 131 and may be in the stuck state. For example, as illustrated in FIG. 7, the hydraulic piston 132 may stop at time T1. At time T1, the measured position of the hydraulic piston 132 is not changed, and the measured speed of the motor 136 may be about “zero.”

The processor 210 may compare the measured speed of the motor 136 with the first reference speed to identify whether the hydraulic piston 132 has been stopped. The first reference speed may be experimentally or empirically preset and stored in the memory 211 in advance.

The processor 210 may determine or identify whether the measured speed of the motor 136 is lower than the first reference speed based on a result of comparing the measured speed of the motor 136 with the first reference speed.

When the processor 210 determines that the measured speed of the motor 136 is not lower than the first reference speed (e.g. NO in operation 1140), the brake device 10 may continuously control the driving current of the motor 136 to move the hydraulic piston 132 in the forward direction (e.g. a first direction).

When the processor 210 determines that the measured speed of the motor 136 is lower than the first reference speed (e.g. YES in operation 1140), the brake device 10 may identify whether a difference between a measured current value of the motor 136 and a target current value is greater than a first reference current value (operation 1150).

The processor 210 may identify the measured current value supplied to the motor 136 and the target current value based on the motor current signal of the MCS, and compare the difference between the measured current value and the target current value with the first reference current value.

In this case, the measured current value of the motor 136 may follow the reference current. As illustrated in FIG. 7, the reference current and the measured current value may greatly increase and then decrease for a short time when the hydraulic piston 132 starts to be driven. The reference current and the measured current value greatly increase because a large torque is required due to a static friction force when the hydraulic piston 132 starts to move.

In order to prevent the increase in the measured current value when the hydraulic piston 132 starts to move from being confused with the increase in the measured current value due to the sticking of the hydraulic piston 132 or to distinguish a normal state in which the measured current value is increased because the hydraulic piston 132 starts to move from an abnormal state in which the measured current value is increased because the hydraulic piston 132 is stuck, the processor 210 may stop, or does not perform, the comparison of the difference between the measured current value and the target current value with the first reference current value for a predetermined first time after starting to move the hydraulic piston 132.

When the predetermined first time elapses after starting to move the hydraulic piston 132, the processor 210 may identify the measured current value supplied to the motor 136 and the target current value based on the motor current signal of the MCS.

Here, the target current value may be a value of a current corresponding to the target pressure. As the target pressure increases, a force for moving the hydraulic piston 132, that is, a torque required for the motor 136, may increase. An increase in the torque required for the motor 136 represents an increase in the driving current supplied to the motor 136. The target current may represent the driving current of the motor 136 required due to the increase in the target pressure. The processor 210 may calculate or identify the target current value based on the target pressure. For example, as illustrated in FIG. 7, the target current may also increase as the target pressure increases.

The processor 210 may compare the difference between the measured current value and the target current value with the first reference current value. Here, the first reference current value may be experimentally or empirically preset and stored in the memory 211 in advance.

When the hydraulic piston 132 is stopped in the cylinder block 131, the difference between the measured current value and the target current value may increase. For example, as illustrated in FIG. 7, the hydraulic piston 132 may stop at time T1. At time T1, the reference current and the measured current value may rapidly increase. The motor driving circuit 220 may increase the reference current so that the measured speed of the motor 136 follows the reference speed when the measured speed of the motor 136 becomes about “zero.” The measured current may also increase together with the increase in the reference current. Therefore, a difference between the measured current value and the target current value may increase and become greater than the first reference current value.

The processor 210 may determine or identify whether the difference between the measured current value and the target current value is greater than the first reference current value based on a result of comparing the difference between the measured current value and the target current value with the first reference current value.

When the processor 210 identifies that the difference between the measured current value and the target current value is not greater than the reference current value (e.g. NO in operation 1150), the brake device 10 may continuously control the driving current of the motor 136 to move the hydraulic piston 132 in the forward direction (e.g. a first direction).

When the processor 210 identifies that the difference between the measured current value and the target current value is greater than the first reference current value (e.g. YES in operation 1150), the brake device 10 may identify whether a time period for which the hydraulic piston has been stopped is greater than the first reference time (operation 1160).

When is the processor 210 identifies that the measured speed of the motor 136 is smaller than the first reference speed and the difference between the measured current value and the target current value is greater than the first reference current value, the processor 210 may identify that the hydraulic piston 132 has been stopped.

The processor 210 may measure a time period for which the hydraulic piston 132 has been stopped based on a result of identifying that the hydraulic piston 132 has been stopped.

For example, the processor 210 may include a counter. When is the processor 210 identifies that the hydraulic piston 132 has been stopped, the processor 210 may increase a value of the counter. Then, when is the processor again identifies that the hydraulic piston 132 has been stopped after a predetermined time period, the processor 210 may increase the value of the counter again. While the processor 210 identifies that the hydraulic piston 132 has been stopped, the processor 210 may continuously increase the value of the counter. When the processor 210 identifies that the difference between the measured current value and the target current value is not greater than the first reference current value or that the measured speed of the motor 136 is not smaller than the first reference speed, the processor 210 may initialize the value of the counter.

The processor 210 may identify whether a time period for which the hydraulic piston 132 has been stopped is greater than the first reference time.

For example, the processor 210 may compare the value of the counter with the first reference value corresponding to the first reference time and identify whether the value of the counter is greater than the first reference value.

When the processor 210 identifies that the time period for which the hydraulic piston 132 has been stopped is not greater than the first reference time (e.g. NO in operation 1160), the brake device 10 may continuously control the driving current of the motor 136 to move the hydraulic piston 132 in the forward direction (e.g. a first direction).

When the processor 210 identifies that the time period for which the hydraulic piston 132 has been stopped is greater than the first reference time (e.g. YES in operation 1160), the brake device 10 may identify the stuck state of the hydraulic piston 132 in which the hydraulic piston 132 is stuck in the cylinder block 131 (operation 1170).

The processor 210 may identify that the hydraulic piston 132 has been stuck in the cylinder block 131 based on a result of identifying that the time period for which the hydraulic piston 132 has been stopped is greater than the first reference time. For example, as illustrated in FIG. 7, the processor 210 may identify that the hydraulic piston 132 has been stuck in the cylinder block 131 based on a time when the hydraulic piston 132 is stopped between time T1 and time T2. That is, the processor 210 may identify the stuck state of the hydraulic piston 132 in which the hydraulic piston 132 is stuck in the cylinder block 131.

The processor 210 may switch the operation mode of the brake device 10 to the fallback mode based on a result of identifying the stuck state of the hydraulic piston 132.

In the operation mode, the brake device 10 operates the hydraulic pressure supply unit 130 to supply the medium to the wheel cylinders 31, 32, 33, and 34. In the fallback mode, the brake device 10 may stop the operation of the hydraulic pressure supply unit 130 and directly supply the pressurized medium discharged from the master cylinder 120 to the wheel cylinders 31, 32, 33, and 34. For example, in the fallback mode, the driving of the motor 136 may be stopped, the first cut valve 171a and the second cut valve 172a may be opened, and the pressurized medium discharged from the master cylinder 120 may be supplied to the wheel cylinders 31, 32, 33, and 34.

As described above, the brake device 10 may identify whether the hydraulic piston 132 is in the stuck state based on the rotating speed and/or the driving current of the motor 136 while the hydraulic piston 132 moves forward.

In operation 1150, the processor 210 may determine or identify whether the difference between the measured current value and the target current value is greater than the first reference current value, but the present disclosure is not limited thereto. For example, the processor 210 may compare the measured current value with a first upper current limit, and identify whether the measured current value is greater than the first upper current limit.

In operation 1160, the processor 210 may identify that the hydraulic piston 132 has been stopped when the processor 210 identifies that the measured speed of the motor 136 is lower than the first reference speed and the measured current value is greater than the first upper current limit, and identify whether the time period for which the piston 132 has been stopped is greater than the first reference time.

In operation 1170, the processor 210 may determine or identify that the hydraulic piston 132 is in the stuck state in which the hydraulic piston 132 is stuck in the cylinder block 131 when the time period for which the hydraulic piston 132 has been stopped is greater than the first reference time.

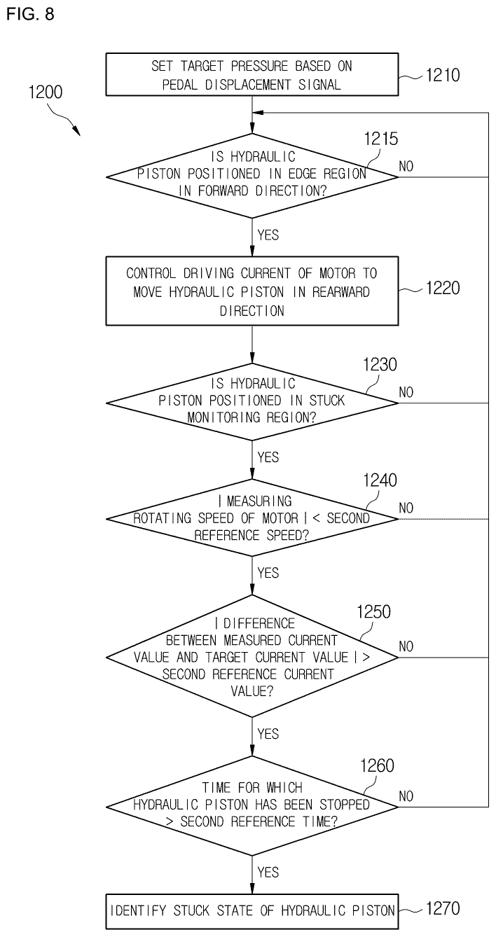

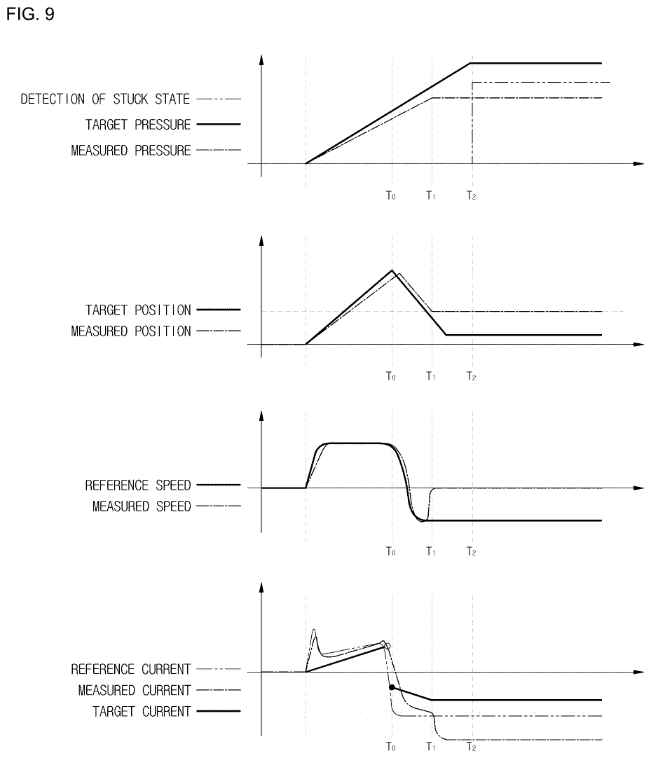

FIG. 8 is a flowchart for illustrating a method of detecting a stuck state of a hydraulic piston by a brake device according to an embodiment of the present disclosure. FIG. 9 is graphs illustrating examples of a hydraulic pressure, a rotating speed of a motor, a position of a hydraulic piston, and a driving current according to the embodiment illustrated in FIG. 8.

A method 1200 of detecting the stuck state of the hydraulic piston by the brake device 10 will be described with reference to FIGS. 8 and 9. The method 1200 of detecting the stuck state in which the hydraulic piston 132 is stuck in the cylinder block 131 may be executed at predetermined times.

One or more operations to be described below may not be essential operations of the method 1200 of detecting the stuck state, and one or more of the operations may be omitted.

The brake device 10 may set the target pressure based on the pedal displacement signal (operation 1210).

Operation 1210 may be the same as, or similar to, operation 1110 illustrated in FIG. 5.

The brake device 10 may identify whether the hydraulic piston 132 is positioned in the edge region in the forward direction (operation 1215).

While moving the hydraulic piston 132 in the forward direction (e.g. a direction away from the motor), the processor 210 may identify the measured position of the hydraulic piston 132 based on the motor position signal of the MPS.

The processor 210 may identify whether the measured position of the hydraulic piston 132 is in the edge region of the cylinder block 131 based on the measured position of the hydraulic piston 132.

When the hydraulic piston 132 is not positioned in the edge region in the forward direction (e.g. NO in operation 1215), the brake device 10 may continuously move the hydraulic piston 132 in the forward direction (e.g. a first direction).

When the hydraulic piston 132 is positioned in the edge region in the forward direction (e.g. YES in operation 1215), the brake device 10 may control the driving current of the motor 136 to move the hydraulic piston 132 in the rearward direction (a second direction opposite to or different from the first direction) (operation 1220).

The processor 210 may identify a target position of the hydraulic piston 132 based on the target pressure and the pressure-volume characteristic curve.

The target pressure may increase according to the driver's braking intention. Therefore, for example, as illustrated in FIG. 9, the target position of the hydraulic piston 132 that moves in the forward direction may be moved in the rearward direction (e.g. a direction closer to the motor 136) at time TO.

The processor 210 may identify the linear displacement of the hydraulic piston 132 based on the motor position signal of the MPS. The processor 210 may identify the current position (hereinafter referred to as a “measured position”) of the hydraulic piston 132 by accumulating the linear displacement of the hydraulic piston 132 at the reference position of the hydraulic piston 132.

The processor 210 may provide a reference speed so that the measured position of the hydraulic piston 132 follows the target position based on a difference between the target position and the measured position of the hydraulic piston 132. For example, as illustrated in FIG. 9, the reference speed that is a positive value may be changed to a negative value to change a direction of the hydraulic piston 132 after time TO. In this case, the reference speed may be set to a predetermined reference speed or set based on the moving speed of the brake pedal 50.

The processor 210 may identify the rotating speed (hereinafter referred to as a “measured speed”) of the motor 136 based on the motor rotation signal of the MPS.

The processor 210 may provide a reference current so that the measured speed of the motor 136 follows the reference speed based on a difference between the reference speed and the measured speed of the motor 136. For example, as illustrated in FIG. 9, the reference current that is a positive value may be changed to a negative value to change the direction of the hydraulic piston 132 after time TO.

The processor 210 may provide the motor control signal to the motor driving circuit 220 so that the driving current of the motor 136 follows the reference current. The motor driving circuit 220 may control the driving current supplied to the motor 136 according to the motor control signal of the processor 210.

As illustrated in FIG. 7, up to time T1, the measured current may follow the reference current, the measured speed may follow the reference speed, the measured position may follow the target position, and in addition, the measured pressure measured by the first pressure sensor PS1 may follow the target pressure.

The brake device 10 may identify whether the hydraulic piston 132 is positioned in the stuck monitoring region SM of FIG. 6 (operation 1230).

Operation 1230 may be the same as or similar to operation 1130 illustrated in FIG. 5.

When the processor 210 identifies that the hydraulic piston 132 is not positioned in the stuck monitoring region SM (e.g. NO in operation 1230), the brake device 10 may continuously control the driving current of the motor 136 to move the hydraulic piston 132 in the rearward direction (e.g. the second direction).

When is the processor 210 identifies that the hydraulic piston 132 is positioned in the stuck monitoring region SM (e.g. YES in operation 1230), the brake device 10 may identify whether an absolute value of the measured speed of the motor 136 is smaller than a second reference speed (operation 1240).

The processor 210 may compare the absolute value of the measured speed of the motor 136 with the second reference speed to identify whether the hydraulic piston 132 has been stopped. As illustrated in FIG. 9, the measured speed of the motor 136 may have the negative value while the hydraulic piston 132 moves backward. The second reference speed may be experimentally or empirically preset and stored in the memory 211 in advance.

When the processor 210 identifies that the absolute value of the measured speed of the motor 136 is not smaller than the second reference speed (e.g. NO in operation 1240), the brake device 10 may continuously control the driving current of the motor 136 to move the hydraulic piston 132 in the rearward direction (e.g. the second direction).

When is the processor 210 identifies that the absolute value of the measured speed of the motor 136 is smaller than the second reference speed (e.g. YES in operation 1240), the brake device 10 may identify whether an absolute value of the difference between the measured current value of the motor 136 and the target current value is greater than a second reference current value (operation 1250).

In order to prevent the increase in the measured current value when the hydraulic piston 132 starts to move from being confused with the increase in the measured current value due to the sticking of the hydraulic piston 132 or to distinguish a normal state in which the measured current value is increased because the hydraulic piston 132 starts to move from an abnormal state in which the measured current value is increased because the hydraulic piston 132 is stuck, the processor 210 may stop the comparison of the difference between the measured current value and the target current value with the second reference current value for a predetermined second time after starting to change the moving direction of the hydraulic piston 132.

The processor 210 may identify the measured current value supplied to the motor 136 and the target current value when the second predetermined time elapses after starting to move the hydraulic piston 132, and compare the absolute value of the difference between the measured current value and the target current value with the second reference current value. As illustrated in FIG. 9, while the hydraulic piston 132 moves backward, the measured current value and the target current value may have negative values.

The second reference current value may be experimentally or empirically preset and stored in the memory 211 in advance.

When the hydraulic piston 132 is stopped in the cylinder block 131, the difference between the measured current value and the target current value may increase. For example, as illustrated in FIG. 9, the hydraulic piston 132 may stop at time T1. At time T1, the reference current and the measured current value may rapidly increase. Therefore, the absolute value of the difference between the measured current value and the target current value may increase and become greater than the second reference current value.

When the processor 210 identifies that the absolute value of the difference between the measured current value and the target current value is not greater than the second reference current value (e.g. NO in operation 1250), the brake device 10 may continuously control the driving current of the motor 136 to move the hydraulic piston 132 in the rearward direction (e.g. the second direction).

When is the processor 210 identifies that the absolute value of the difference between the measured current value and the target current value is greater than the second reference current value (e.g. YES in operation 1250), the brake device 10 may identify whether a time period for which the hydraulic piston has been stopped is greater than the second reference time (operation 1260).

Operation 1260 may be the same as, or similar to, operation 1160 illustrated in FIG. 5.

When the processor 210 identifies that a time period for which the hydraulic piston 132 has been stopped is not greater than the first reference time (e.g. NO in operation 1260), the brake device 10 may continuously control the driving current of the motor 136 to move the hydraulic piston 132 in the rearward direction (e.g. the second direction).

When is the processor 210 identifies that the time period for which the hydraulic piston 132 has been stopped is greater than the second reference time (e.g. YES in operation 1260), the brake device 10 may identify the stuck state of the hydraulic piston 132 (operation 1270).

The processor 210 may switch the operation mode of the brake device 10 to the fallback mode based on a result of identifying the stuck state of the hydraulic piston 132.

As is apparent from the above description, the brake device 10 may identify whether the hydraulic piston 132 is in the stuck state based on the rotating speed and/or the driving current of the motor 136 while the hydraulic piston 132 moves backward.

In operation 1250, the processor 210 has identified whether the absolute value of the difference between the measured current value and the target current value is greater than the second reference current value, but the present disclosure is not limited thereto. For example, the processor 210 may compare the measured current value with a second upper current limit and identify whether the absolute value of the measured current value is greater than the second upper current limit.

In operation 1260, the processor 210 may identify that the hydraulic piston 132 has been stopped when is the processor 210 identifies that the measured speed of the motor 136 is lower than the second reference speed and the absolute value of the measured current value is greater than the second upper current limit and identify whether the time period for which the piston 132 has been stopped is greater than the first reference time.

In operation 1270, the processor 210 may identify that the hydraulic piston 132 is in the stuck state when the time period for which the hydraulic piston 132 has been stopped is greater than the second reference time.

Therefore, it is an aspect of the present disclosure to provide an apparatus capable of detecting an out-of-order state or an out-of-control state of a brake and a method of controlling the same. Therefore, the apparatus can suppress, prevent, or minimize damage to peripheral devices due to a failure of the apparatus and suppress, prevent, or minimize accidents caused by the failure of the brake.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A brake apparatus comprising:
a master cylinder;
a pump including a cylinder block and a piston configured to be linearly movable in the cylinder block;
a motor configured to generate a force for linearly moving the piston of the pump;
a plurality of first valves provided on a first flow path extending from the pump to a wheel cylinder;
at least one second valve provided on a second flow path extending from the master cylinder to the wheel cylinder; and
a processor configured to control the plurality of first valves to open the first flow path extending from the pump to the wheel cylinder, control the at least one second valve to block the second flow path extending from the master cylinder to the wheel cylinder, and perform control of the motor for moving the piston in a first direction,
wherein the processor is configured to, based on a rotating speed of the motor and a driving current of the motor while performing the control of the motor for moving the piston in the first direction, stop the control of the motor and control the at least one second valve to open the second flow path extending from the master cylinder to the wheel cylinder.

2. The brake apparatus of claim 1, wherein the processor is configured to:
set a target pressure based on an output signal of a sensor configured to sense a brake input; and
set a target current based on the target pressure.

3. The brake apparatus of claim 1, wherein the processor is configured to, based on whether the rotating speed of the motor is lower than a reference speed and a difference between the driving current of the motor and a target current of the motor is greater than a reference value, stop the control of the motor and control the at least one second valve to open the second flow path extending from the master cylinder to the wheel cylinder.

4. The brake apparatus of claim 1, wherein the processor is configured to, when a state in which the rotating speed of the motor is lower than a reference speed and a difference between the driving current of the motor and a target current of the motor is greater than a reference value continues for a reference time or longer, stop the control of the motor and control the at least one second valve to open the second flow path extending from the master cylinder to the wheel cylinder.

5. The brake apparatus of claim 1, wherein the processor is configured to, based on whether the piston is positioned in a monitoring region of the cylinder block, the rotating speed of the motor is lower than a reference speed, and a difference between the driving current of the motor and a target current of the motor is greater than a reference value, stop the control of the motor and control the at least one second valve to open the second flow path extending from the master cylinder to the wheel cylinder.

6. The brake apparatus of claim 1, wherein the processor is configured to continue to perform the control of the motor for a predetermined time from a start of the control of the motor for moving the piston in the first direction without stopping the control of the motor.

7. The brake apparatus of claim 1, wherein the processor is configured to control the motor to move the piston in a second direction, different from the first direction, based on whether a distance between the piston and an edge of the cylinder block is within a predetermined range.

8. The brake apparatus of claim 7, wherein:
the cylinder block of the pump is divided into a first chamber and a second chamber by the piston, and
the processor is configured to:
control the plurality of first valves to open a third flow path extending from the first chamber of the cylinder block to the wheel cylinder while performing the control of the motor for moving the piston in the first direction; and
control the plurality of first valves to open a fourth flow path extending from the second chamber of the cylinder block to the wheel cylinder while performing the control of the motor for moving the piston in the second direction.

9. A method of controlling a brake apparatus, the method comprising:
controlling a plurality of first valves, provided on a first flow path extending from a pump to a wheel cylinder, to open the first flow path, wherein the pump includes a cylinder block and a piston configured to be linearly movable in the cylinder block;
controlling at least one second valve, provided on a second flow path extending from a master cylinder to the wheel cylinder, to block the second flow path;
controlling a motor to move the piston in a first direction; and
based on a rotating speed of the motor and a driving current of the motor while performing the controlling of the motor to move the piston in the first direction, stopping the controlling of the motor and controlling the at least one second valve to open the second flow path extending from a master cylinder to the wheel cylinder.

10. The method of claim 9, further comprising:
setting a target pressure based on an output signal of a sensor configured to sense a brake input; and
setting a target current based on the target pressure.

11. The method of claim 9, wherein the stopping of the controlling of the motor and the controlling of the at least one second valve comprises, based on whether the rotating speed of the motor is lower than a reference speed and a difference between the driving current of the motor and a target current of the motor is greater than a reference value, stopping the controlling of the motor and controlling the at least one second valve to open the second flow path extending from the master cylinder to the wheel cylinder.

12. The method of claim 9, wherein the stopping of the controlling of the motor and the controlling of the at least one second valve comprises, when a state in which the rotating speed of the motor is lower than a reference speed and a difference between the driving current of the motor and a target current of the motor is greater than a reference value continues for a reference time or longer, stopping the controlling of the motor and controlling the at least one second valve to open the second flow path extending from the master cylinder to the wheel cylinder.

13. The method of claim 9, wherein the stopping of the controlling of the motor and the controlling of the at least one second valve comprises, based on whether the piston is positioned in a monitoring region of the cylinder block, the rotating speed of the motor is lower than a reference speed, and a difference between the driving current of the motor and a target current of the motor is greater than a reference value, stopping the controlling of the motor and controlling the at least one second valve to open the second flow path extending from the master cylinder to the wheel cylinder.

14. The method of claim 9, further comprising continuing to perform the controlling of the motor to move the piston in the first direction for a predetermined time from a start of the controlling of the motor to move the piston in the first direction without stopping the controlling of the motor.

15. The method of claim 9, further comprising controlling the motor to move the piston in a second direction, different from the first direction, based on whether a distance between the piston and an edge of the cylinder block is within a predetermined range.

16. A brake apparatus comprising:
a master cylinder;
a pump including a cylinder block, and a piston dividing the cylinder block into a first chamber and a second chamber and configured to be linearly movable in the cylinder block;
a motor configured to generate a force for linearly moving the piston of the pump;
a plurality of first valves provided on a first flow path extending from at least one of the first chamber or the second chamber of the cylinder block to a wheel cylinder;
at least one second valve provided on a second flow path extending from the master cylinder to the wheel cylinder; and
a processor configured to control the plurality of first valves so that the first flow path extends from the first chamber or the second chamber to the wheel cylinder, control the at least one second valve to block the second flow path extending from the master cylinder to the wheel cylinder, and control the motor to move the piston in a first direction,
wherein the processor is configured to:
based on whether a distance between the piston and an edge of the cylinder block is within a predetermined range, control the motor to move the piston in a second direction different from the first direction, and
based on a rotating speed of the motor and a driving current of the motor while controlling the motor, stop a control of the motor and control the at least one second valve to open the second flow path extending from the master cylinder to the wheel cylinder.

17. The brake apparatus of claim 16, wherein the processor is configured to, based on whether the rotating speed of the motor is lower than a reference speed and the driving current of the motor is greater than an upper current limit, stop the control of the motor and control the at least one second valve to open the second flow path extending from the master cylinder to the wheel cylinder.

18. The brake apparatus of claim 16, wherein the processor is configured to, when a state in which the rotating speed of the motor is lower than a reference speed and the driving current of the motor is greater than an upper current limit continues for a reference time or longer, stop the control of the motor and control the at least one second valve to open the second flow path extending from the master cylinder to the wheel cylinder.

19. The brake apparatus of claim 16, wherein the processor is configured to, based on whether the piston is positioned in a monitoring region of the cylinder block, the rotating speed of the motor is lower than a reference speed, and the driving current of the motor is greater than an upper current limit, stop the control of the motor and control the at least one second valve to open the second flow path extending from the master cylinder to the wheel cylinder.

20. The brake apparatus of claim 16, wherein the processor is configured to continue the control of the motor to move the piston in the first direction for a predetermined time after a start of controlling the motor to move the piston in the first direction without stopping the control of the motor.
